(19) United States
(12) Patent Application Publication
(10) Pub. No.: US 2022/0037949 A1
(43) Pub. Date: Feb. 3, 2022

(54) APPARATUS WITH MECHANICAL ELECTRIC ENERGY GENERATION FOR AUDIO PROCESSING

(71) Applicant: ZOY OY, Vantaa (FI)

(72) Inventors: Krista KINNUNEN, Vantaa (FI); Mika GRÖHN, Vantaa (FI); Marko SARASMO, Vantaa (FI); Tomi HAUTALA, Vantaa (FI)

(21) Appl. No.: 17/274,956

(22) PCT Filed: Sep. 12, 2019
(86) PCT No.: PCT/FI2019/050652

§ 371 Date: Mar. 10, 2021

(30) Foreign Application Priority Data
Sep. 13, 2018 (FI) 20185763

(51) Int. Cl. H02K 5/04; H02K 7/02; H02K 7/116; H04R 1/10

(52) U.S. Cl. CPC H02K 5/04; H04R 1/1041; H02K 7/116; H02K 7/02

(57) ABSTRACT

An apparatus (100) with mechanical electric energy generation for audio processing. A mechanical module (110) includes an interface (112) configured to receive rotation (160) from a user, a disc-shaped flywheel rotor (114) with permanent magnets (116, 118), and a gearing (120) configured to increase speed of the rotation (160). An electronics module (130) includes a disc-shaped stator (132) with coils (134, 136) to generate electric energy (170) for powering the electronics module (130) during rotation of the disc-shaped flywheel rotor (114). The electronics module (130) is configured to record an audio (180) with a microphone (138) into a non-volatile memory (140), and to play the audio (182) from the non-volatile memory (140) with a speaker (142). A designed housing (150) is configured to accommodate and protect the mechanical module (110) and the electronics module (130).

### FIELD

Various example embodiments relate to an apparatus with mechanical electric energy generation for audion processing.

### BACKGROUND

US 2010/0077797 A1 discloses a decorative recording module, which may include at least one power source such as a battery, a rechargeable battery, a disposable battery, a solar cell, a kinetic power source, or a power source converting heat energy to electricity.

U.S. Pat. No. 9,398,790 B1 discloses a personal recording necklace and pendant system, which uses a battery.

WO 2015/121524 A1 discloses an element of jewellery with a personalized aural message, wherein a battery powers electronics.

However, the prior art is not concerned with longevity of the apparatus. If the apparatus is a valuable item of jewellery, possibly made of precious metal, capable of storing and playing audio, it should last long and continue to function even one hundred years or more. If the apparatus is a user authentication device, it should operate reliably in all situations. The use of batteries does not offer such a solution. US 2010/0077797 A1 does mention a kinetic power source, but it does not disclose any details of implementation, and, hence, its longevity or reliability is not proven.

### BRIEF DESCRIPTION

According to an aspect, there is provided an apparatus as specified in claim 1.

### LIST OF DRAWINGS

Some example embodiments will now be described with reference to the accompanying drawings, in which

FIG. 1 illustrates example embodiments of an apparatus;

FIG. 2, FIG. 3, FIG. 4, FIG. 5, FIG. 6, FIG. 7 and FIG. 8 illustrate further example embodiments of the apparatus as an item of jewellery;

FIG. 9A and FIG. 9B illustrate further example embodiments of the apparatus a musical box; and

FIG. 10 illustrates further example embodiments of the apparatus as a user identification device.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Reference numbers, both in the description of the example embodiments and in the claims, serve to illustrate the example embodiments with reference to the drawings, without limiting it to these examples only.

The embodiments and features, if any, disclosed in the following description that do not fall under the scope of the independent claims are to be interpreted as examples useful for understanding various embodiments of the invention.

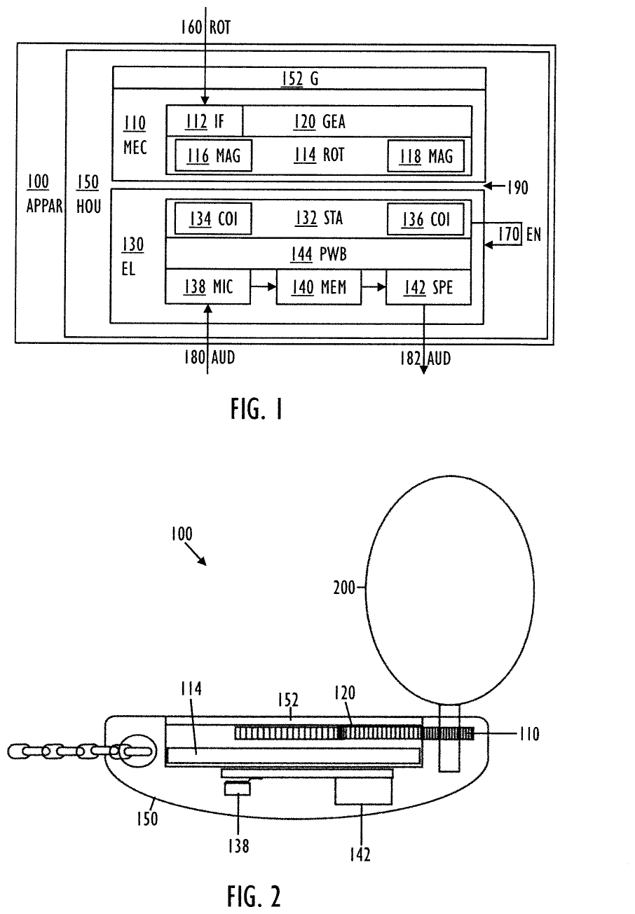

Let us study FIG. 1 illustrating an apparatus 100 with mechanical electric energy generation for audio processing.

In an example embodiment, the apparatus 100 is an item 100 of jewellery. The item 100 of jewellery may be a pendant, bracelet, necklace, brooch, or any other type of a small decorative item worn by women or men, for example.

In an example embodiment, the apparatus 100 is a musical box. The musical box 100 may be an electronic version of a mechanical music box capable of playing a musical piece.

In an example embodiment, the apparatus 100 is a memento. The memento 100 may be a souvenir, statue, or another type of keepsake, which is typically kept at home or office in view, hanging on a wall or from a ceiling, or on a mantelpiece, a bookshelf or a desk, for example.

In an example embodiment, the apparatus 100 is a user identification device. The user identification device 100 may interact with a user authentication device in order to verify a user's identity to a computer system, to a bank system, to a physical access control system, or to another type of system requiring a strong user identification and authentication.

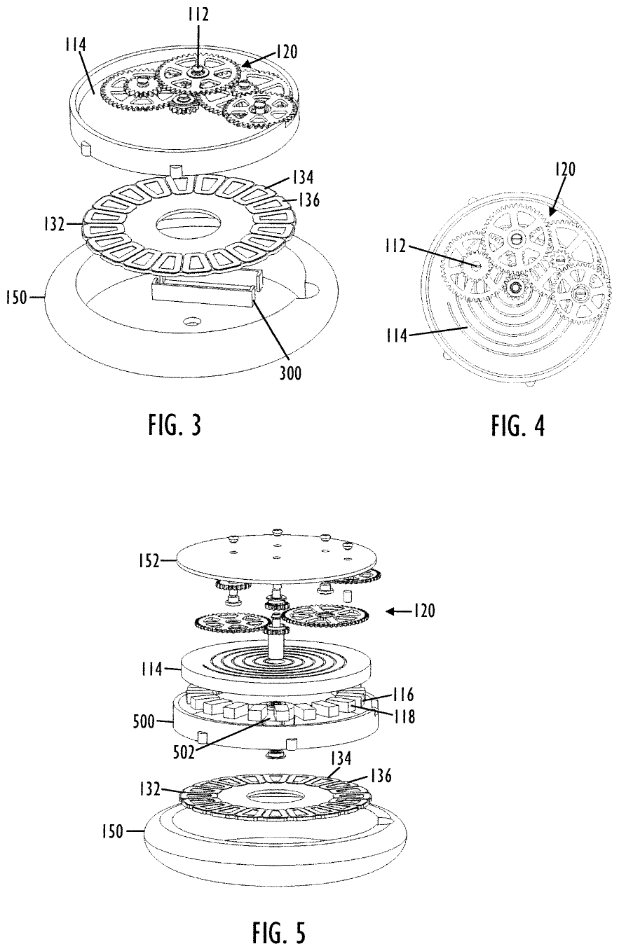

Simultaneously, FIG. 2, FIG. 3, FIG. 4, FIG. 5, FIG. 6, FIG. 7 and FIG. 8 are also referred to while explaining further example embodiments of the item 100 of jewellery.

The apparatus 100 comprises three main structures: a mechanical module 110, an electronics module 130, and a designed housing 150.

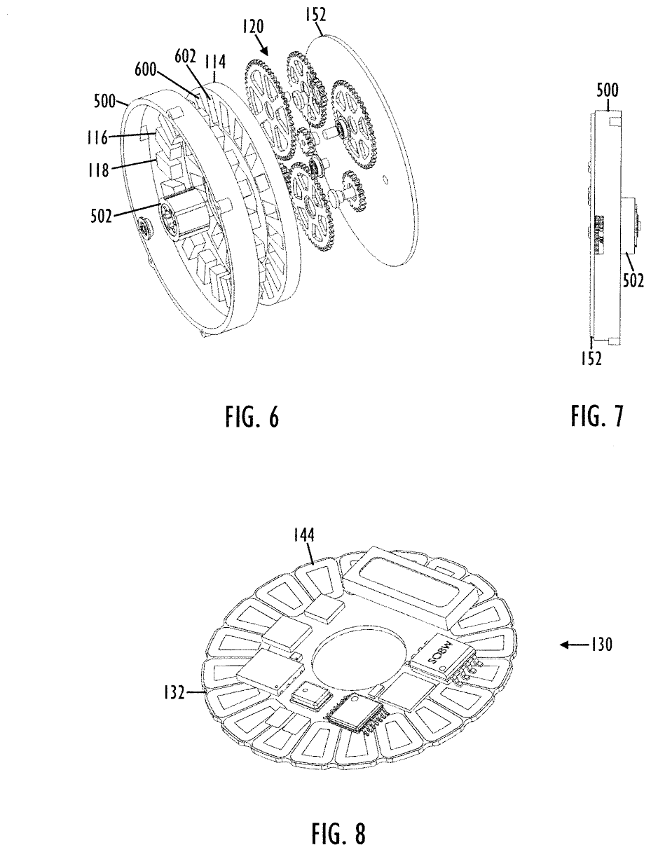

The mechanical module 110 includes an interface 112 configured to receive rotation 160 from a user. As shown in FIG. 2, the interface 112 may be configured to accommodate a (possibly detachable) winding key 200. The interface 112 may as well be a turn-knob 900 as shown in FIGS. 9A and 9B for the musical box 100, or some other kind of manually manipulable mechanism to receive the rotation 160 from the user.

The mechanical module 110 includes a disc-shaped flywheel rotor 114 embedded with a plurality of permanent magnets 116, 118 and configured to rotate next to a disc-shaped stator 132.

The disc-shaped flywheel rotor 114 is an integrated structure integrating the rotor and the flywheel. The disc-shaped flywheel rotor 114 may be manufactured by casting or machining, for example. The permanent magnets 116, 118 may be embedded to the disc-shaped flywheel rotor 114 by a fixing, an adhesive, and/or by an interference fit. The function of the flywheel is to efficiently store rotational energy. This is achieved by the fact that the flywheel resists changes in rotational speed by its moment of inertia. The flywheel functionality is configured so that an audio track of a moderate length, less than one minute, for example, may be recorded and later played with the generated electric energy 170. Accordingly, the flywheel may rotate one minute, for example. The flywheel 114 may be equipped with a free rolling clutch bearing 502.

The disc-shaped flywheel rotor 114 may include high-density metal such as tungsten (wolfram) to store more rotational energy as compared to a flywheel made of steel.

The disc-shaped flywheel rotor 114 may include a plurality of cavities 600, 602 accommodating the plurality of the permanent magnets 116, 118. In this way, the total thickness of the rotor-stator structure may be kept to a minimum.

The mechanical module 110 includes a gearing 120 coupled from the interface 112 to the disc-shaped flywheel rotor 114 and configured to increase speed of the rotation 160. The user may be capable of providing the rotation 160 with a relatively low rate, such as between 10 to 100 rotations per minute, but the gearing 120 may increase the speed of the rotation 160 considerably, such as to 5000 rotations per minute, for example. A torque limiter/clutch may be used to protect the gearing 120. The disc-shaped flywheel rotor 114 and the gearing 120 may be fitted into a frame 500.

The electronics module 130 includes the disc-shaped stator 132 embedded with a plurality of coils 134, 136 and configured and positioned next to the disc-shaped flywheel rotor 114 to generate electric energy 170 for powering the electronics module 130 during rotation of the disc-shaped flywheel rotor 114.

The disc-shaped flywheel rotor 114 embedded with the plurality of the permanent magnets 116, 118 and the disc-shaped stator 132 embedded with the plurality of the coils 134, 136 implement a generator employing an electromagnetic induction for generating the electric energy 170.

As shown in FIG. 3, the disc-shaped flywheel rotor 114 and the disc-shaped stator 132 may be configured and positioned on top of each other. The plurality of the coils 134, 136 may be placed in series and/or in parallel around a perimeter of the disc-shaped stator 132, and the permanent magnets 116, 118 may be placed in a similar fashion around a perimeter of the disc-shaped flywheel rotor 114. The permanent magnets 116, 118 may be placed so that adjacent magnets 116, 118 always have the opposite poles side-by-side, i.e. the first magnet 116 has its South pole facing the perimeter, whereas the second magnet 118 has its North pole facing the perimeter.

The permanent magnets 116, 118 may be neodymium magnets so that the magnetic forces are high in relation to size of the permanent magnets 116, 118.

The electronics module 130 includes a microphone 138, a non-volatile memory 140, and a speaker 142.

The microphone 138 may be of MEMS type, whose output type is digital (PDM) and connects directly to a main MCU to avoid any audio amplifier stages.

The speaker 142 may be configured to be bandwidth-limited (to human voice frequencies) and designed so that its audio output is easily hearable within a 10 to 15 cm distance, whereby the user may listen to the audio 182 by placing the item 100 of jewellery in the vicinity of the ear. Such use enables the electronics module 130 to function with a small amount of electric energy 170. A high-efficiency audio codec/headphone amplifier may be needed, such as Cirrus Logix CS42L4, which has an internal charge pump to boost headphone amplifier efficiency. The speaker 142 may be a high-impedance/high-sensitivity speaker, and, possibly, of a type “IHF” (integrated hands-free), which is commonly used in mobile phones, such as PUI audio AR01532MS-SC15-WP-R. The mechanical design of the speaker 142 may include front and back cavities to get optimal audio output.

In an example embodiment, the electronics module 130 is configured such that the recorded and played audio is in a human hearing range and comprises one or more of the following: a human voice, an animal sound, an engine sound, a natural sound, a man-made sound, music. This example embodiment may operate in the item 100 of jewellery as described, but it may also operate in the musical box 100 or in the memento 100.

FIG. 9A and FIG. 9B illustrate the musical box 100 with the designed housing 150 and the turn-knob 900. The musical box 100 may comprise an openable lid 902. The speaker 142 may be placed in a concave cavity 904 or 906, which may amplify the played audio.

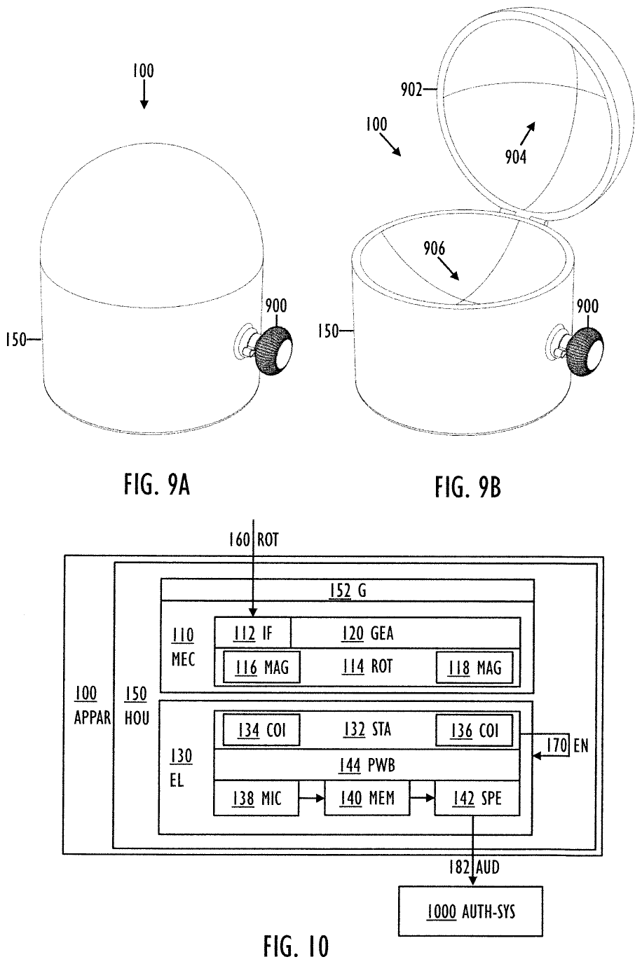

In an example embodiment, the electronics module 130 is configured such that the recorded and played audio is outside of a human hearing range and comprises a human voice in an altered frequency range (the speaker 142 may be configured to be bandwidth-limited to be outside of the human voice frequencies and human hearing range) outputted to an external user authentication device 1000. This example embodiment may operate in the user identification device 100 described in FIG. 10. The user identification and authentication is based on comparing the received audio with a stored audio in the external user authentication device: if they match, the authentication is successful, else the authentication fails. This example embodiment may necessitate heavy encryption for the non-volatile memory 140 and other security features to prevent an unauthorized use of the user identification device 100.

The non-volatile memory 140 is used as a long-term persistent memory to store the recorded audio 180. The non-volatile memory 140 is able to retrieve the recorded audio 180 even after having been power cycled (turned off and on) again and again. If ADPCM (Adaptive differential pulse-code modulation) algorithm is used to encode the audio 180, a 60-second recording consumes 4 bit×60 s×16000 Hz (sample rate)=3.84 Mbit of memory space.

The electronics module 130 is configured to record an audio 180 with the microphone 138 into the non-volatile memory 140, and to play the audio 182 from the non-volatile memory 140 with the speaker 142.

Note that the electronics module 130 may comprise, for fulfilling its configured operations, other parts, such as required wiring, one or more microcontroller units (MCU), an adaptive audio amplifier, etc. But, in order to have the life-cycle of one hundred years, it does not comprise batteries or other electronic components whose life-time expectancy is less than one hundred years. This is achieved by generating and using the electric energy for powering the electronics module 130 only during the rotation 160. In a way, the electric energy 170 is used in real-time, during the rotation 160, and it is not stored for later use. Naturally, properties of the electronics module 130 may make it possible to use the electric energy 170 for a short time after the rotation of the disc-shaped flywheel rotor 114 is stopped or is slowing down.

A hardware bootup may be performed as follows. The electronics module 130 may include two MCU's. So-called boot MCU has no internal flash memory, only a ROM bootloader. The bootloader is loading code from an external FRAM (ferromagnetic RAM). The FRAM stores a boot MCU firmware and main MCU firmware. After the boot MCU is started, it resets the main MCU and starts to upload firmware to the main MCU RAM by using an SWD interface. The main MCU is started and the FRAM is taken in use. The main MCU internal flash is not used due to a low data retention time. If the electronics module 130 is detecting enough power, then the electronics module 130 starts depending on a user interface mode: either starting to record or to play an existing audio record.

The electronics module 130 may be configured so that once the audio 180 has been recorded with a pleasing result, the result is write-protected, i.e., further recording is no more possible, but the user may play the recorded audio 182 for an innumerable number of times.

FIG. 8 illustrates that the disc-shaped stator 132 may be manufactured on a side of a printed wiring board 144, and other parts 138, 140, 142 of the electronics module 130 may be fixed to another side of the printed wiring board 144, whereby the distance between the rotor 114 and the stator 132 may be minimized.

The designed housing 150 is configured to accommodate and protect the mechanical module 110 and the electronics module 130. The housing 150 may include precious metal, gemstones, etc., but it is configured to be shockproof, waterproof and dustproof with use of appropriate buffers, seals, etc. The housing 150 may be “designed” (by an artist or an industrial designer) in the sense that aesthetic and adornment functions of the item 100 of jewellery are fulfilled. The item 100 of jewellery retains beautiful design, even though the sophisticated mechanism enables recording and playback of the audio, by a loved one, for example. As long as the internal structures of the designed housing 150 are configured and dimensioned to accommodate standard mechanical and electronics modules 110, 130, the external appearance of the designed housing 150 may vary infinitely. As shown in FIG. 3, the housing 150 may include internal structures 300 for accommodating and protecting the electronics module 130.

In summary, the apparatus 100 is capable of recording and storing the audio 180, and, at a later time, play the audio 182 from the non-volatile memory 140.

In an example embodiment, the gearing 120 is configured to operate only during receiving the rotation 160 from the user, and after that only the disc-shaped flywheel rotor 114 rotates. As the gearing 120 may cause noise, it is desirable that its operation is stopped before recording or playing the audio. The electronics module 130 may be configured to start recording the audio 180 while only the disc-shaped flywheel rotor 114 rotates. The electronics module 130 may be configured to start playing the audio 182 while only the disc-shaped flywheel rotor 114 rotates. This may be implemented so that there is a mechanism, which notes that the rotation 160 is stopped.

In an example embodiment, the interface 112 is on one side of the apparatus 100, and the microphone 138 and speaker 142 are on another side of the apparatus 100. This may simplify design and use, as the separate functions, energy generation, and recording/playing are on different sides.

In an example embodiment, the gearing 120 is attached to a transparent glass 152 of the designed housing 150. The transparent glass 152 enables observation of the gearing 120 and the disc-shaped flywheel rotor 114 by the user. Such observation is both aesthetically pleasing and also gives the user feedback on proper use and functioning of the mechanical module 110.

In an example embodiment, the mechanical module 110 is separated from the electronics module 130 by a void space 190. The void space 190 serves to separate the mechanics and the electronics in order to increase the life-time expectancy. In effect, there is no galvanic connection from the mechanical module 110 to the electronics module 130, although the distance from the rotor 114 to the stator 132 needs to be as small as possible for the best power generating efficiency.

It will be obvious to a person skilled in the art that, as technology advances, the inventive concept can be implemented in various ways. The invention and its embodiments are not limited to the example embodiments described above but may vary within the scope of the claims.

1. An apparatus comprising:
a mechanical module;
an electronics module including a microphone, a non-volatile memory, and a speaker, wherein the electronics module is configured to record an audio with the microphone into the non-volatile memory, and to play the audio from the non-volatile memory with the speaker; and
a designed housing;
wherein the mechanical module includes an interface configured to receive rotation from a user, a disc-shaped flywheel rotor embedded with a plurality of permanent magnets and configured to rotate next to a disc-shaped stator, and a gearing coupled from the interface to the disc-shaped flywheel rotor and configured to increase speed of the rotation,
the electronics module includes a disc-shaped stator embedded with a plurality of coils and configured and positioned next to the disc-shaped flywheel rotor to generate electric energy for powering the electronics module during rotation of the disc-shaped flywheel rotor, and
the designed housing is configured to accommodate and protect the mechanical module and the electronics module.

2. The apparatus of claim 1, wherein the disc-shaped flywheel rotor and the disc-shaped stator are configured and positioned on top of each other.

3. The apparatus of claim 1, wherein the disc-shaped flywheel rotor is an integrated structure integrating the rotor and the flywheel.

4. The apparatus of claim 1, wherein the disc-shaped flywheel rotor includes high-density metal such as tungsten and a plurality of cavities accommodating the plurality of the permanent magnets.

5. The apparatus of claim 1, wherein the disc-shaped stator is manufactured on a side of a printed wiring board, and other parts of the electronics module are fixed to another side of the printed wiring board.

6. The apparatus of claim 1, wherein the gearing is configured to operate only during receiving the rotation from the user, and after that only the disc-shaped flywheel rotor rotates.

7. The apparatus of claim 6, wherein the electronics module is configured to start recording the audio while only the disc-shaped flywheel rotor rotates.

8. The apparatus of claim 6, wherein the electronics module is configured to start playing the audio while only the disc-shaped flywheel rotor rotates.

9. The apparatus of claim 1, wherein the interface is on one side of the apparatus, and the microphone and speaker are on another side of the apparatus.

10. The apparatus of claim 1, wherein the gearing is attached to a transparent glass of the designed housing, the transparent glass enabling observation of the gearing and the disc-shaped flywheel rotor by the user, and the mechanical module is separated from the electronics module by a void space.

11. The apparatus of claim 1, wherein the apparatus is an item of jewellery, or a musical box, or a memento.

12. The apparatus of claim 11, wherein the electronics module is configured such that the recorded and played audio is in a human hearing range and comprises one or more of the following: a human voice, an animal sound, an engine sound, a natural sound, a man-made sound, music.

13. The apparatus of claim 1, wherein the apparatus is a user identification device.

14. The apparatus of claim 13, wherein the electronics module is configured such that the recorded and played audio is outside of a human hearing range and comprises a human voice in an altered frequency range outputted to an external user authentication device.
